(19) United States
(12) Patent Application Publication
(10) Pub. No.: US 2002/0084875 A1
(43) Pub. Date: Jul. 4, 2002

(54) Planar filter with a zero-degree feed structure

(76) Inventors: Chih-Ming Tsai, Taipei City (TW); Sheng-Yuan Lee, Tao-Yuan Hsien (TW)

Correspondence Address: BAKER BOTTS LLP, C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 09/969,623

(22) Filed: Oct. 4, 2001

(30) Foreign Application Priority Data
Dec. 31, 2000 (TW) 089127549

(51) Int. Cl. H01P 1/20

(52) U.S. Cl. 333/204

(57) ABSTRACT

A planar filter includes a ground plane underlying a dielectric substrate, and input and output resonators provided on the dielectric substrate. Each of the input and output resonators has a feed point provided on a transmission line conductor that is divided by the feed point into a long transmission line segment and a short transmission line segment, each which has an open end. A first signal path is defined from a first feed point provided on the input resonator to a second feed point provided on the output resonator. A second signal path is defined from the second feed point to the first feed point. A phase difference between the first and second signal paths is substantially equal to zero degree when the filter operates at a central operating frequency thereof.

### BACKGROUND OF THE INVENTION

1. Field of the Invention

The invention relates to a planar filter, more particularly to a planar filter with a zero-degree feed structure.

2. Description of the Related Art

The circuit design related to radio frequency and microwave circuits has a current trend toward small size and high performance. For example, general transmission line resonators have been widely used in cellular telephones, base station and satellite communication, and can be fabricated using circuit board fabricating (PCB), low temperature co-fired ceramic (LTCC), monolithic microwave integrated circuit (MMIC) and high-temperature superconductor (HTS) techniques.

FIG. 1 shows a conventional planar filter 1 that includes a dielectric substrate 11 having opposite surfaces 111, 112, a ground plane 12 provided on the surface 111, and input and output resonators 13, 14 provided on the surface 112. Each of the input and output resonators 13, 14 is a half-wavelength hairpin resonator that has a transmission line conductor 131, 141. Each of the transmission line conductors 131, 141 has an intermediate section 132, 142 with opposite first and second ends, and opposite end sections 133, 143 extending from the first and second ends of the intermediate section 132, 142 toward the other of the input and output resonators 13, 14. Each of the end sections 133, 143 has a coupling end connected integrally to a respective one of the first and second ends of the intermediate sections 132, 142, and an open end 134, 144 opposite to the coupling end. The input resonator 13 further has a first feed point 130 provided on the intermediate section 132 of the transmission line conductor 131. The output resonator 14 further has a second feed point 140 provided on the intermediate section 142 of the transmission line conductor 141. The filter 1 further includes an input line 135 connected to the input resonator 13 at the first feed point 130, and an output line 145 connected to the output resonator 14 at the second feed point 140. A first signal path is defined from the first feed point 130 of the input resonator 13 to the second feed point 140 of the output resonator 14. A second signal path is defined from the second feed point 140 of the output resonator 14 to the first feed point 130 of the input resonator 13. The filter 1 has a central operating frequency. A phase difference between the first and second signal paths is not equal to zero degree when the filter 1 operates at the central operating frequency. As such, the filter 1 has a non-zero-degree feed structure. Alternatively, each of the first and second feed points 130, 140 can be provided on one of the end sections 132, 142. In this case, the input and output lines 135, 145 are indicated by the imaginary-line portions in FIG. 1.

In actual practice, the input and output resonators of a planar filter with a non-zero-degree feed structure can be designed in different ways. Referring to FIG. 2, the input and output resonators 21, 22 of another conventional planar filter 2 with a non-zero-degree feed structure are shown to be in the form of a stepped-impedance hairpin resonator. The open ends 211, 212 of the input resonator 21 face and are spaced apart from the open ends 221, 222 of the output resonator 22. The input and output resonators can also be in the form of a square open-loop resonator, a slow-wave open-loop resonator, etc.

When an embodiment of a planar filter with a non-zero-degree feed structure according to the conventional planar filter 2 is designed with the central operating frequency at 2.0 GHz and 5% bandwidth, and is fabricated on the Rogers RO4003 substrate with a dielectric constant of 3.38, a loss tangent of 0.0027 and a thickness of 20 mil, FIGS. 3 and 4 illustrate the measured frequency responses of the embodiment at the passband 36, and the stopband 37 and the higher-order spurious, respectively. In FIG. 3, the central operating frequency 35 of the embodiment is about 2.0 GHz, and the bandwidth of the passband 36 is about 5% of the central operating frequency 35. In FIG. 4, there is no extra transmission zero at the stopband 37, thereby resulting in relatively poor out-of-band rejection.

### SUMMARY OF THE INVENTION

Therefore, the object of the present invention is to provide a planar filter with a zero-degree feed structure that has two extra transmission zeros close to the passband so as to enhance the out-of-band rejection.

According to the present invention, a planar filter comprises:

a dielectric substrate having opposite surfaces;

a ground plane provided on one of the surfaces; and

a plurality of resonating elements provided on the other one of the surfaces, the resonating elements including input and output resonators, the input resonator having a first transmission line conductor, and a first feed point provided on the first transmission line conductor, the first transmission line conductor being divided by the first feed point into a first long transmission line segment and a first short transmission line segment shorter than the first long transmission line segment, each of the first long and short transmission line segments having a first open end, the output resonator having a second transmission line conductor, and a second feed point provided on the second transmission line conductor, the second transmission line conductor being divided by the second feed point into a second long transmission line segment and a second short transmission line segment shorter than the second long transmission line segment, each of the second long and short transmission line segments having a second open end, a first signal path being defined from the first feed point of the input resonator to the second feed point of the output resonator through the first long transmission line segment of the input resonator and the second short transmission line segment of the output resonator, a second signal path being defined from the second feed point of the output resonator to the first feed point of the input resonator through the second long transmission line segment of the output resonator and the first short transmission line segment of the input resonator, the filter having a central operating frequency, a phase difference between the first and second signal paths being substantially equal to zero degree when the filter operates at the central operating frequency.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a conventional planar filter;

FIG. 2 is a schematic top view of another conventional planar filter;

FIG. 3 is a measured frequency response plot at the passband for an embodiment of the conventional planar filter of FIG. 2;

FIG. 4 is a measured frequency response plot at the stopband for the embodiment of the conventional planar filter of FIG. 2;

FIG. 5 is a perspective view showing the preferred embodiment of a planar filter according to the present invention;

FIG. 6 is a measured frequency response plot at the passband for an embodiment according to the present invention;

FIG. 7 is a measured frequency response plot at the stopband for the embodiment according to the present invention;

FIG. 8 is a schematic top view showing the second preferred embodiment of a planar filter according to the present invention; and

FIG. 9 is a schematic top view showing the third preferred embodiment of a planar filter according to the present invention.

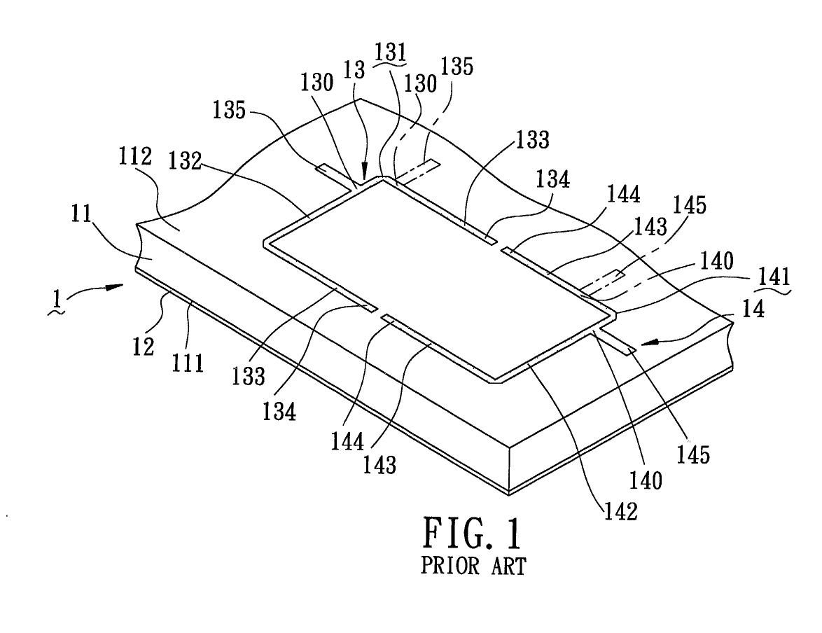

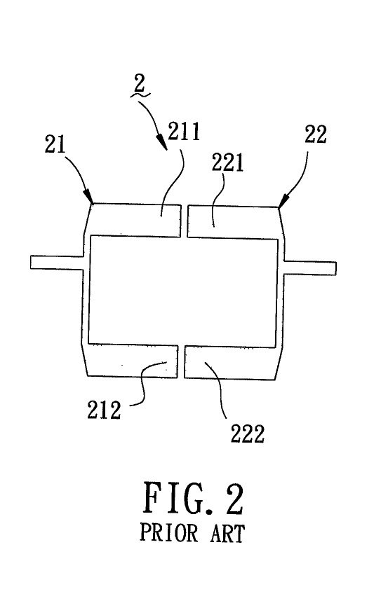

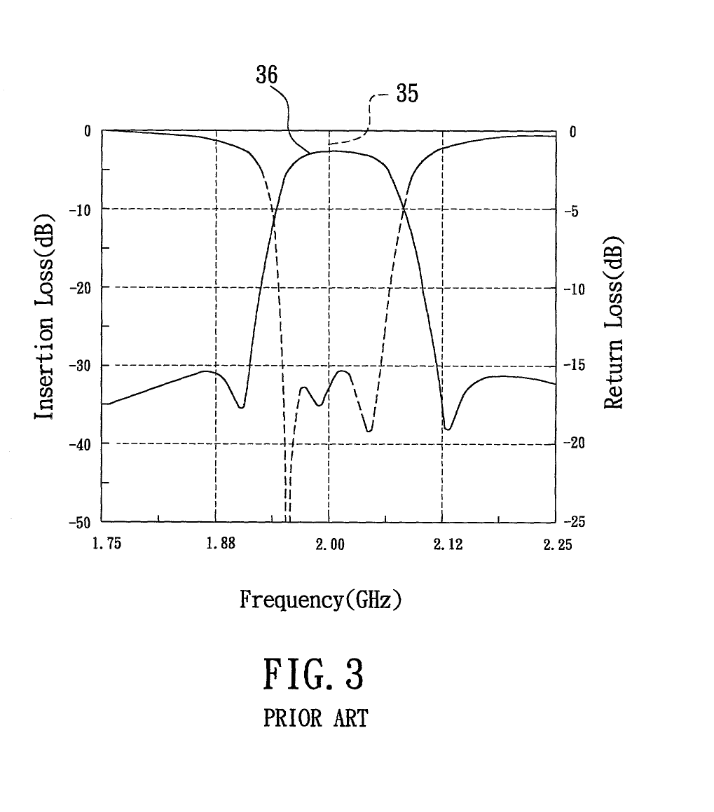

### DETAILED DESCRIPTION OF THE PREFERRED EMBODIMENTS

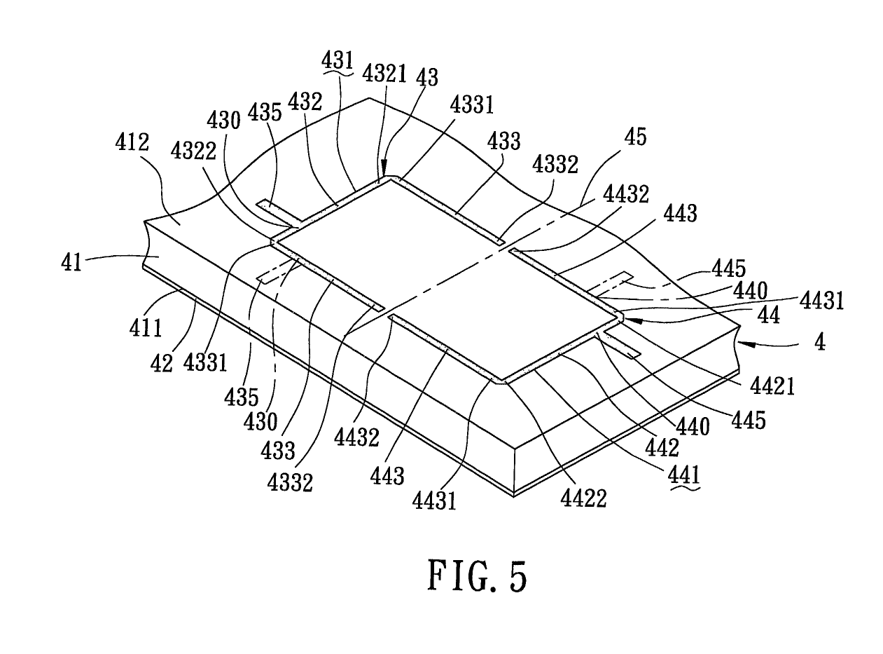

Referring to FIG. 5, according to the preferred embodiment of the present invention, a planar filter 4 is shown to include a dielectric substrate 41, aground plane 42, and input and output resonators 43, 44. The dielectric substrate 41 has opposite surfaces 411, 412. The ground plane 42 is provided on the surface 411 of the dielectric substrate 41. The input and output resonators 43, 44 are provided on the surface 412 of the dielectric substrate 41.

In this embodiment, each of the input and output resonators 43, 44, such as hairpin resonators, is symmetrical about a longitudinal center axis, and has a transmission line conductor 431, 441. The transmission line conductor 431 of the input resonator 43 has an intermediate section 432 that extends along a first direction parallel to the longitudinal center axis 45 and that has opposite first and second ends 4321, 4322. The transmission line conductor 441 of the output resonator 44 has an intermediate section 442 that extends along the first direction and that has opposite first and second end 4421, 4422. Each of the input and output resonators 43, 44 further has opposite end sections 433, 443 extending toward the other of the input and output resonators 43, 44 in a second direction transverse to the first direction. Each of the end sections 433 of the input resonator 43 has a coupling end 4331 connected integrally to a respective one of the first and second ends 4321, 4322 of the intermediate section 432, and an open end 4332 opposite to the coupling end 4331. Each of the end sections 443 of the output resonator 44 has a coupling end 4431 connected integrally to a respective one of the first and second ends 4421, 4422 of the intermediate section 442, and an open end 4432 opposite to the coupling end 4431.

The input resonator 43 further has a first feed point 430 provided on the transmission line conductor 431 thereof such that the transmission line conductor 431 is divided by the first feed point 430 into a first long transmission line segment and a first short transmission line segment, each of which has one of the open ends 4332. The first short transmission line segment is shorter than the first long transmission line segment. The output resonator 44 further has a second feed point 440 provided on the transmission line conductor 441 thereof such that the transmission line conductor 441 is divided by the second feed point 440 into a second long transmission line segment and a second short transmission line segment, each of which has one of the open ends 4432. The second short transmission line segment is shorter than the second long transmission line segment. In this embodiment, the first feed point 430 is provided on the intermediate section 432 of the input resonator 43. The second feed point 440 is provided on the intermediate section 442 of the output resonator 44.

The filter 4 further includes an input line 435 connected to the input resonator 43 at the first feed point 430, and an output line 445 connected to the output resonator 44 at the second feed point 440.

A first signal path is defined from the first feed point 430 of the input resonator 43 to the second feed point 440 of the output resonator 44 through the first long transmission line segment of the transmission line conductor 431 and the second short transmission line segment of the transmission line conductor 441. A second signal path is defined from the second feed point 440 of the output resonator 44 to the first feed point of the input resonator 43 through the second long transmission line segment of the transmission line conductor 441 and the first short transmission line segment of the transmission line conductor 431. The filter 4 has a central operating frequency. A phase difference between the first and second signal paths is substantially equal to zero degree when the filter 4 operates at the central operating frequency. As such, the filter 4 has a zero-degree feed structure.

Alternatively, the first feed point 430 can be provided on one of the end sections 433 of the input resonator 43, and the second feed point 440 can be provided on one of the end sections 443 of the output resonator 440. In this case, the input and output lines 435, 445 are indicated by the imaginary-line portions in FIG. 5.

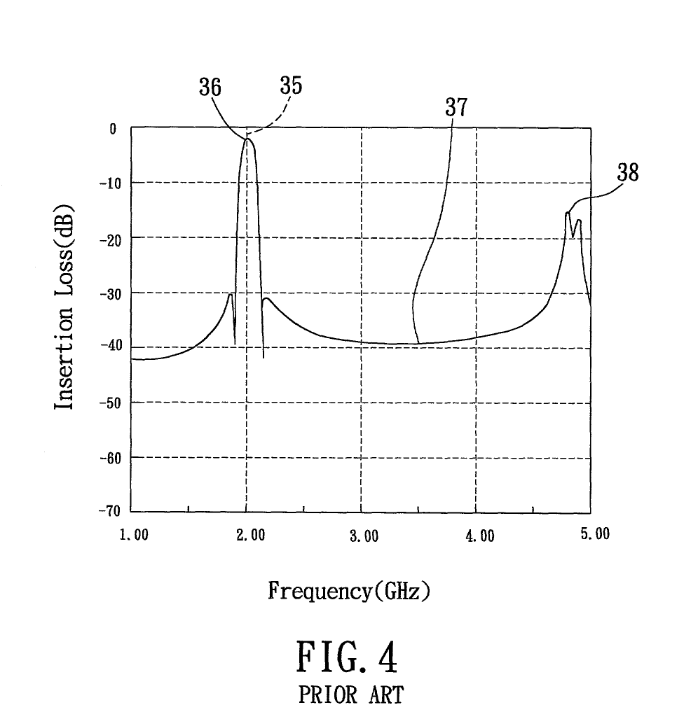

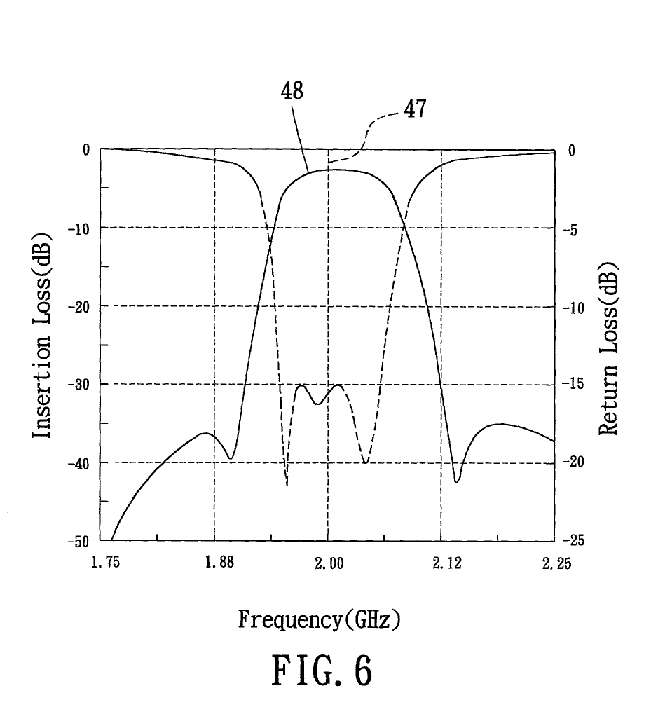

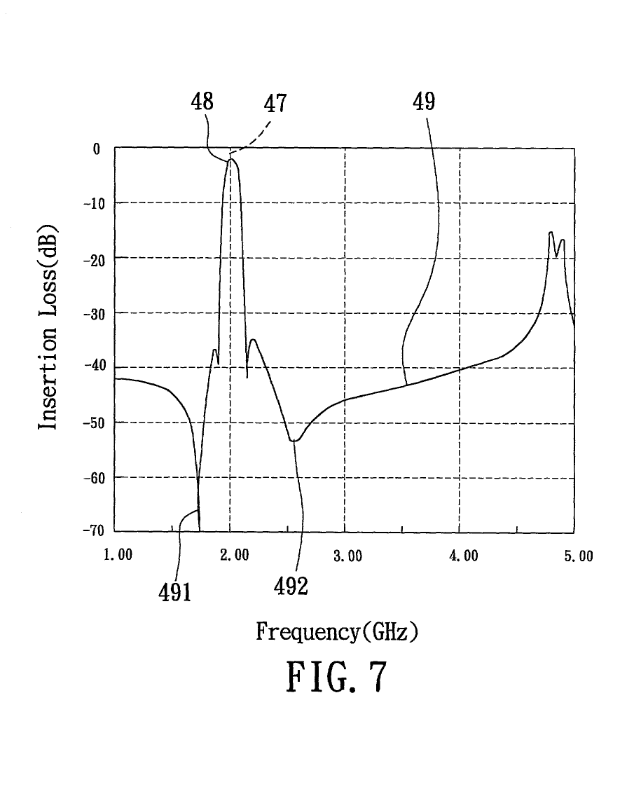

When an embodiment of a planar filter with a zero-degree feed structure according to the present invention is designed with the central operating frequency at 2.0 GHz and 5% bandwidth, and is fabricated on the Rogers RO4003 substrate with a dielectric constant of 3.38, a loss tangent of 0.0027 and a thickness of 20 mil, FIGS. 6 and 7 illustrate the measured frequency responses of the embodiment at the passband 48 and the stopband 49, respectively. In FIG. 6, the central operating frequency 47 of the embodiment is about 2.0 GHz, and the bandwidth of the passband 48 is about 5% of the central operating frequency 47 such that the embodiment can be normally operated at the passband 48. In FIG. 7, there are two extra transmission zeros 491, 492 at the stopband 49 when compared to FIG. 4, which illustrates the frequency response of the aforesaid conventional planar filter with a non-zero-degree feed structure at the stopband 37. It is noted that, due to the presence of the two extra transmission zeros 491, 492 close to the central operating frequency 47, the filter of this invention can suppress interference signals adjacent to the passband 48, thereby resulting in enhanced out-of-band rejection.

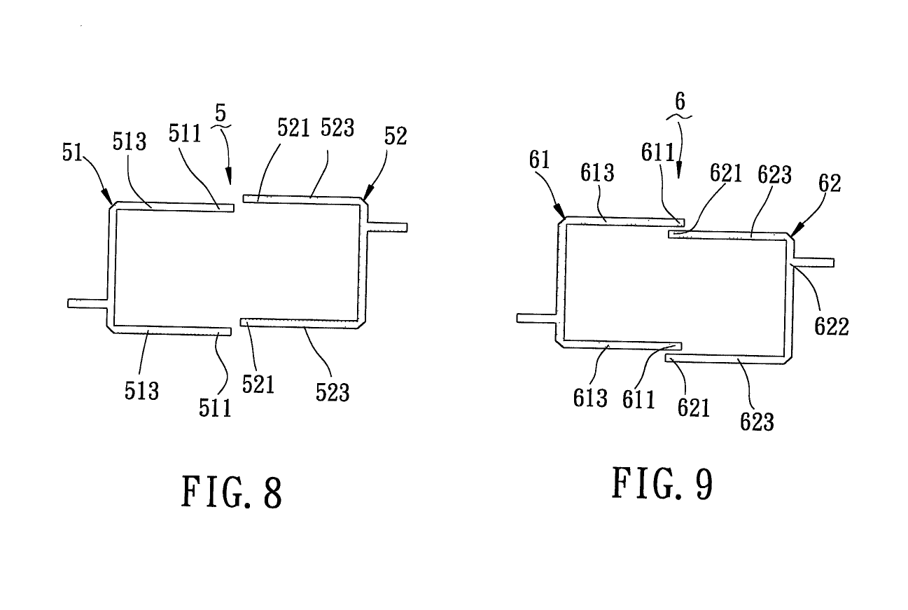

FIG. 8 illustrates the second preferred embodiment of the present invention, which is a modification of the first preferred embodiment. Unlike the previous embodiment, the open ends 511 of the end sections 513 of the input resonator 51 are staggered with respect to the open ends 521 of the end sections 523 of the output resonator 52. The open ends 511 of the end sections 513 of the input resonator 51 are spaced apart from the open ends 521 of the end sections 523 of the output resonator 52 in the second direction.

FIG. 9 illustrates the third preferred embodiment of the present invention, which is a modification of the second preferred embodiment. Unlike the previous embodiment, each of the open ends 611 of the end sections 613 of the input resonator 61 overlaps and is spaced apart from a respective one of the open ends 621 of the end sections 623 of the output resonator 62 in the first direction.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. A planar filter comprising:
at least one dielectric substrate having opposite surfaces;
a ground plane provided on one of said surfaces; and
a plurality of resonating elements provided on the other one of said surfaces, said resonating elements including input and output resonators, said input resonator having a first transmission line conductor, and a first feed point provided on said first transmission line conductor, said first transmission line conductor being divided by said first feed point into a first long transmission line segment and a first short transmission line segment shorter than said first long transmission line segment, each of said first long and short transmission line segments having a first open end, said output resonator having a second transmission line conductor, and a second feed point provided on said second transmission line conductor, said second transmission line conductor being divided by said second feed point into a second long transmission line segment and a second short transmission line segment shorter than said second long transmission line segment, each of said second long and short transmission line segments having a second open end, a first signal path being defined from said first feed point of said input resonator to said second feed point of said output resonator through said first long transmission line segment of said input resonator and said second short transmission line segment of said output resonator, a second signal path being defined from said second feed point of said output resonator to said first feed point of said input resonator through said second long transmission line segment of said output resonator and said first short transmission line segment of said input resonator, said filter having a central operating frequency, a phase difference between said first and second signal paths being substantially equal to zero degree when said filter operates at the central operating frequency.

2. A planar filter comprising:
at least one dielectric substrate having opposite surfaces;
a ground plane provided on one of said surfaces; and
a plurality of resonating elements provided on the other one of said surfaces, said resonating elements including input and output resonators, each of said input and output resonators having a transmission line conductor, said transmission line conductor having an intermediate section that extends along a first direction and that has opposite first and second ends, each of said input and output resonators further having opposite end sections extending toward the other of said input and output resonators in a second direction transverse to the first direction, each of said end sections having a coupling end connected integrally to a respective one of said first and second ends of said intermediate section, and a open end opposite to said coupling end, said input resonator further having a first feed point provided on said transmission line conductor thereof, said output resonator further having a second feed point provided on said transmission line conductor thereof, a first signal path being defined from said first feed point of said input resonator to said second feed point of said output resonator, a second signal path being defined from said second feed point of said output resonator to said first feed point of said input resonator, said filter having a central operating frequency, a phase difference between said first and second signal paths being substantially equal to zero degree when said filter operates at the central operating frequency.

3. The planar filter as claimed in claim 2, wherein said first feed point is provided on said intermediate section of said input resonator, and said second feed point is provided on said intermediate section of said output resonator.

4. The planar filter as claimed in claim 2, wherein said first feed point is provided on one of said end sections of said input resonator, and said second feed point is provided on one of said end sections of said output resonator.

5. The planar filter as claimed in claim 2, further comprising an input line connected to said input resonator at said first feed point, and an output line connected to said output resonator at said second feed point.

6. The planar filter as claimed in claim 3, wherein said open ends of said end sections of one of said input and output resonators are staggered with respect to said open ends of said end sections of the other one of said input and output resonators.

7. The planar filter as claimed in claim 6, wherein said open ends of said end sections of one of said input and output resonators are spaced apart from said open ends of said end sections of the other one of said input and output resonators in the second direction.

8. The planar filter as claimed in claim 7, wherein each of said open ends of said end sections of one of said input and output resonators overlaps and is spaced apart from a respective one of said open ends of said end sections of the other one of said input and output resonators in the first direction.

9. The planar filter as claimed in claim 2, wherein said first feed point divides said input resonator into a first long transmission line segment and a first short transmission line segment shorter than said first long transmission line segment, and said second feed point divides said output resonator into a second long transmission line segment and a second short transmission line segment shorter than said second long transmission line segment, said first signal path passing through said first long transmission line segment of said input resonator and said second short transmission line segment of said output resonator, said second signal path passing through said second long transmission line segment of said output resonator and said first short transmission line segment of said input resonator.
